(19) United States
(12) Patent Application Publication
(10) Pub. No.: US 2025/0142189 A1
(43) Pub. Date: May 1, 2025

(54) CAMERA MODULE

(71) Applicant: Samsung Electro-Mechanics Co., Ltd., Suwon-si (KR)

(72) Inventors: Kyungho HAN, Suwon-si (KR); Junho JEONG, Suwon-si (KR)

(73) Assignee: Samsung Electro-Mechanics Co., Ltd., Suwon-si (KR)

(21) Appl. No.: 18/919,937

(22) Filed: Oct. 18, 2024

(30) Foreign Application Priority Data
Oct. 27, 2023 (KR) 10-2023-0145780

(51) Int. Cl. H04N 23/51; H04N 23/54; H04N 23/55

(52) U.S. Cl. CPC H04N 23/51; H04N 23/54; H04N 23/55

(57) ABSTRACT

A camera module including a lens barrel, an image sensor disposed below the lens barrel along an optical axis direction of the lens barrel and electrically connected to a substrate, and a sub-housing that is disposed between the lens barrel and the substrate and on which an infrared filter is mounted, wherein the sub-housing includes a gas discharge portion penetrating between first and second surfaces facing each other in the optical axis direction, and a central axis along a penetration direction of the gas discharge portion is inclined with respect to the optical axis.

### CROSS-REFERENCE TO RELATED APPLICATIONS

This application claims the benefit under 35 USC 119 (a) of Korean Patent Application No. 10-2023-0145780 filed on Oct. 27, 2023, in the Korean Intellectual Property Office, the entire disclosure of which is incorporated herein by reference for all purposes.

### BACKGROUND

### 1. Field

The present disclosure relates to a camera module.

### 2. Description of the Background

With the remarkable development of information and communication technology and semiconductor technology, supply and use of electronic devices are rapidly increasing. These electronic devices tend to provide various functions by convergence rather than staying in their typical unique domains.

Recently, cameras have been basically adopted in portable electronic devices such as smartphones, tablet PCs, and laptop computers, and an auto focus (AF) function, an image stabilizer function, and a zoom function may be added to the cameras in these portable electronic devices.

In a case of an adhesive such as an epoxy resin used to adhesively fix an infrared filter of a camera module and a sub-housing on which the infrared filter is mounted, gas is generated during curing. An air hole formed through the sub-housing may be provided to discharge this gas. However, there is a need for improvement because foreign matter may be introduced into the camera module or a flare phenomenon may occur, due to air holes.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel, an image sensor disposed below the lens barrel along an optical axis direction of the lens barrel and electrically connected to a substrate, and a sub-housing that is disposed between the lens barrel and the substrate and on which an infrared filter is mounted, wherein the sub-housing includes a gas discharge portion penetrating between first and second surfaces facing each other in the optical axis direction, and a central axis along a penetration direction of the gas discharge portion is inclined with respect to the optical axis.

The gas discharge portion may penetrate upper and lower portions of the sub-housing in a straight line.

The gas discharge portion may have a uniform width with respect to the central axis.

The camera module may further include an adhesive portion disposed to cover at least a portion of the gas discharge portion.

The adhesive portion may be disposed to surround an inner peripheral surface of the gas discharge portion.

The sub-housing may further include a seating portion in which the infrared filter is accommodated and that is disposed to surround an opening of the sub-housing, and a frame portion disposed on an outer portion of the sub-housing to surround the seating portion, and the gas discharge portion may be disposed in the frame portion.

The central axis of the gas discharge portion may be inclined toward the outside of the sub-housing.

The sub-housing may have an opening, and the central axis of the gas discharge portion may be inclined toward the opening of the sub-housing.

The gas discharge portion may have a hollow cylindrical shape.

The gas discharge portion may have a circular cross-sectional shape.

The central axis of the gas discharge portion may be inclined with respect to the first surface of the sub-housing.

The gas discharge portion may be inclined and extended so that the central axis forms a certain angle with the optical axis.

The camera module may further include a lens driver configured to mount and move the lens barrel, and a housing configured to accommodate the lens barrel and the lens driver.

The gas discharge portion may be disposed outside an edge of the infrared filter.

Other features and aspects will be apparent from the following detailed description, the drawings, and the claims.

### BRIEF DESCRIPTION OF DRAWINGS

FIG. 1 illustrates a schematic cross-sectional view of a camera module according to one or more example embodiments of the present disclosure.

FIG. 2 illustrates a perspective view of a portion of a camera module according to one or more example embodiments of the present disclosure.

FIG. 3 illustrates a cross-sectional view of a portion of a camera module according to one or more example embodiments taken along line III-III′ of FIG. 2.

FIG. 4 illustrates an enlarged cross-sectional view of portion A of a camera module according to one or more example embodiments.

FIG. 5 illustrates a cross-sectional view of a portion of a camera module according to one or more modified example embodiments taken along line V-V′ of FIG. 2.

FIG. 6 illustrates an enlarged cross-sectional view of portion A of a camera module according to one or more still other example embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more embodiments of this disclosure provide a camera module that may easily discharge gas caused by curing of an adhesive material to the outside, effectively block foreign substances from being introduced from the outside, and prevent a flare phenomenon from occurring.

However, the objective of the present disclosure is not limited to the aforementioned.

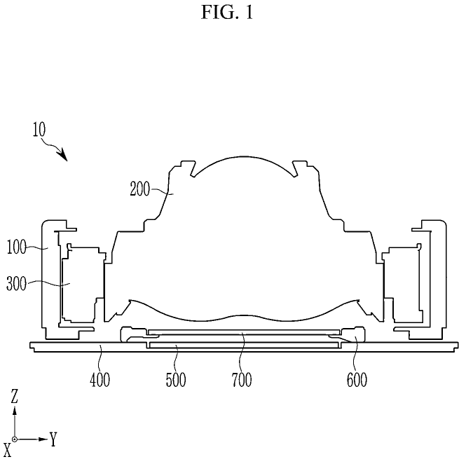

A camera module 10 according to one or more example embodiments will be described with reference to FIG. 1. FIG. 1 illustrates a schematic cross-sectional view of a camera module according to one or more example embodiments.

Referring to FIG. 1, the camera module 10 may include a housing 100, a lens barrel 200, a lens driver 300, a substrate 400, an image sensor 500, a sub-housing 600, and an infrared filter 700.

The housing 100 may accommodate the lens barrel 200 and the lens driver 300. The housing 100 may have a polyhedral shape having a substantially quadrangular cross-section and a predetermined height. However, the shape of the housing 100 is not limited to the polyhedral shape having the quadrangular cross-section.

The lens barrel 200 may have a hollow cylindrical shape so that a plurality of lenses for imaging a subject may be accommodated therein, and the plurality of lenses may be mounted on the lens barrel 200 along an optical axis. The plurality of lenses may be disposed as many as necessary according to the design of the lens barrel 200, and respective lenses may have the same or different optical characteristics, such as a refractive index. The lens barrel 200 may move in an optical axis direction or a direction perpendicular to the optical axis direction while being accommodated in the housing 100 by the driving force of the lens driver.

The lens driver 300 is a device that mounts and moves the lens barrel 200 and may include an auto focus (AF) unit that adjusts focus and an optical image stabilization (OIS) unit that corrects hand shake or shaking. For example, the lens driver may adjust focus or implement a zoom function by moving the lens barrel 200 in the optical axis direction (Z-axis direction in the drawing) using the AF unit, and may correct hand shake or shaking during imaging by moving the lens barrel 200 in a direction perpendicular to the optical axis direction (X-axis or Y-axis direction in the drawing) using the OIS unit.

The substrate 400 may be electrically connected to the lens driver 300. The substrate 400 may be a printed circuit board. The substrate 400 may include a printed circuit board (PCB). The substrate 400 may be coupled to the image sensor 500. A hole accommodating the image sensor 500 may be disposed in the substrate 400, and a support portion made of a stainless steel (SUS) material may be disposed on a lower surface of the substrate 400. However, it is not limited thereto, and the support portion may be made of an insulating material and may be omitted if necessary.

The image sensor 500 may be mounted on the substrate. The image sensor 500 may be disposed on one side of the substrate 400. The image sensor 500 may be disposed under the lens barrel 200 along the optical axis direction. The image sensor 500 may convert light incident through the lens barrel 200 into an electrical signal. For example, the image sensor 500 may be a charge coupled device (CCD) or a complementary metal-oxide semiconductor (CMOS). The electrical signal converted by the image sensor 500 may be outputted as an image through a display unit (not shown) of an electronic device equipped with the camera module 10. The image sensor 500 may be disposed inside the substrate 400, and may be electrically connected to the substrate 400.

The sub-housing 600 and the infrared filter 700 mounted on the sub-housing 600 may be disposed between the substrate 400 and the lens barrel 200. The infrared filter 700 may be disposed under the lens barrel 200 along the optical axis direction of the lens barrel 200. The infrared filter 700 may be disposed inside the sub-housing 600. The infrared filter 700 may be configured to block light of specific wavelengths. For example, the infrared filter 700 may be configured to block infrared light. However, the light blocked by the infrared filter 700 is not limited to infrared light.

The infrared filter 700 may be fixed in various ways. For example, the infrared filter 700 may be bonded and fixed with an ultraviolet curing adhesive material or a heat curing adhesive material, and in this case, the adhesive material may be formed of an epoxy material. In addition, it is also possible to use all possible adhesive members such as adhesive tape.

As described above, the housing 100 and the sub-housing 600 may define an inner space in which the lens barrel 200, the lens driver 300, and the image sensor 500 are accommodated.

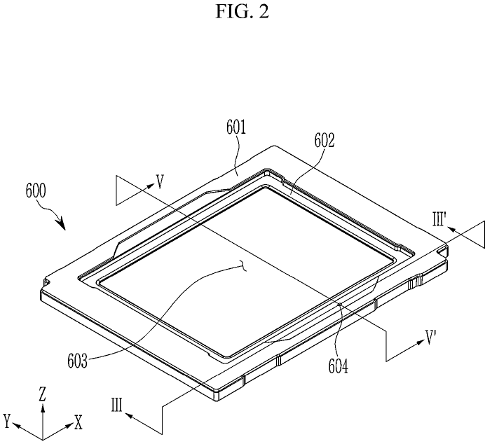

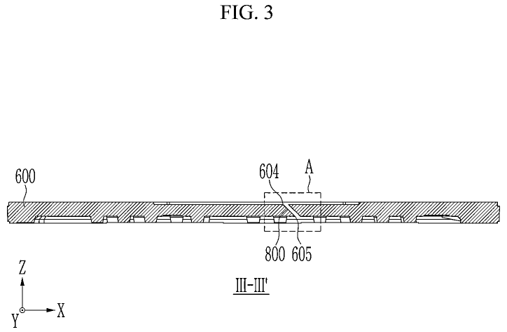

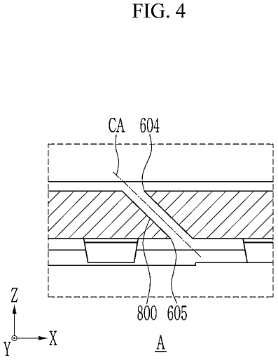

Hereinafter, the sub-housing 600 of the camera module 10 according to one or more example embodiments of the present disclosure will be described in more detail with reference to FIG. 2 to FIG. 4. FIG. 2 illustrates a perspective view of a portion of a camera module according to one or more example embodiments of the present disclosure, FIG. 3 illustrates a cross-sectional view of a portion of a camera module according to one or more example embodiments taken along line III-III′ of FIG. 2, and FIG. 4 illustrates an enlarged cross-sectional view of portion A of a camera module according to one or more example embodiments.

The sub-housing 600 may have a quadrangular planar shape. The sub-housing 600 may have an opening 603 at its center, and the image sensor 500 may be disposed within the opening 603 of the sub-housing 600. The opening 603 of the sub-housing 600 may also have a quadrangular planar shape.

The sub-housing 600 may have a step in the optical axis direction, and may include a frame portion 601 and a seating portion 602 that are sequentially connected.

The seating portion 602 may be disposed to surround the opening 603. The opening 603 may at least partially overlap the image sensor 500. The seating portion 602 may be disposed between the opening 603 and the frame portion 601. The infrared filter 700 may be accommodated and installed in the seating portion 602. In terms of height along the optical axis direction, the height of the seating portion 602 may be lower than the height of the frame portion 601. The seating portion 602 may have a quadrangle planar shape, but is not limited thereto.

The frame portion 601 may be supported on the substrate 400. The frame portion 601 may space the seating portion 602 from the substrate 400. The frame portion 601 may be disposed on the outer portion of the sub-housing 600 to surround the opening 603. The frame portion 601 may be disposed to surround the seating portion 602.

A space portion may be formed inside the sub-housing 600 due to the opening 603 of the sub-housing 600. The infrared filter 700 may be disposed at the upper portion of the space portion, and the image sensor 500 may be disposed at the lower portion thereof.

The sub-housing 600 may have a first surface and a second surface opposite to the first surface in the optical axis direction. Specifically, the first surface may be a surface facing the lens barrel 200, and the second surface may be a surface facing the image sensor 500.

The sub-housing 600 may have a gas discharge portion penetrating between the first and second surfaces facing each other in the optical axis direction. The gas discharge portion 800 may penetrate from the first surface to the second surface of the sub-housing 600. Accordingly, gas generated when the infrared filter 700 and the sub-housing 600 are bonded may be discharged from the inner space of the sub-housing 600 to the outside of the sub-housing 600.

A central axis CA along the penetration direction of the gas discharge portion 800 may be inclined with respect to the optical axis. The central axis CA of the gas discharge portion 800 may be inclined to form an angle with the optical axis. The central axis CA of the gas discharge portion 800 may be inclined toward the outside of the sub-housing 600. The central axis CA of the gas discharge portion 800 may be inclined toward one outer edge of the sub-housing 600 adjacent thereto. However, it is not limited thereto, and any shape is possible as long as the central axis CA of the gas discharge portion 800 is inclined to form an angle with the optical axis.

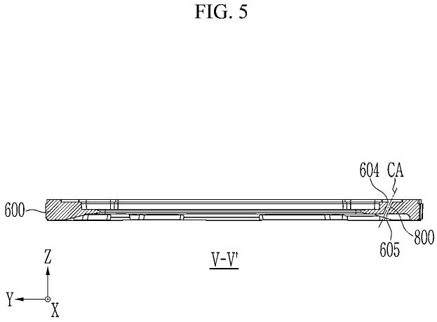

FIG. 5 illustrates a cross-sectional view of a portion of a camera module according to one or more modified example embodiments taken along line V-V′ of FIG. 2.

For example, referring to FIG. 5, the central axis CA of the gas discharge portion 800 may be inclined toward the inside of the sub-housing 600. The central axis CA of the gas discharge portion 800 may be inclined toward the opening 603. The central axis CA of the gas discharge portion 800 may be inclined toward one inner edge of the sub-housing 600 adjacent thereto. The inner edge of the sub-housing 600 may be an edge defining the opening 603.

The central axis CA of the gas discharge portion 800 may be inclined to form an angle with the first surface of the sub-housing 600. The central axis CA of the gas discharge portion 800 may be inclined to form an angle with the second surface of the sub-housing 600. The gas discharge portion 800 may be inclined so that the central axis CA thereof forms a certain angle with the optical axis. The gas discharge portion 800 may be inclined and extended so that the central axis CA thereof forms a constant angle with the optical axis. Accordingly, the gas discharge portion 800 may penetrate the upper and lower portions of the sub-housing 600 in a straight line.

As described above, as the central axis CA of the gas discharge portion 800 is inclined to form an angle with the optical axis, light unnecessarily reflected through the gas discharge portion 800 may be blocked to prevent the occurrence of a flare phenomenon.

The gas discharge portion 800 may have a uniform width with respect to the central axis CA. The width of the gas discharge portion 800 may be measured according to a direction perpendicular to the optical axis direction and parallel to one edge of the sub-housing 600. The gas discharge portion 800 may have a hollow cylindrical shape. The gas discharge portion 800 may have a circular cross-sectional shape. However, the gas discharge portion 800 shape and the cross-sectional shape thereof are not limited thereto, and any shape that allows gas to pass through the gas discharge portion 800 is possible, so the gas discharge portion 800 may have a hollow polygonal pillar shape, and the gas discharge portion 800 may have a polygonal cross-sectional shape.

As an example, the gas discharge portion 800 may be disposed in the frame portion 601. The frame portion 601 may have a first opening 604 through which the gas discharge portion 800 penetrates to be disposed on the first surface, and a second opening 605 through which the gas discharge portion 800 penetrates to be disposed on the second surface. In other words, the first opening 604 and the second opening 605 may be disposed at both ends of the gas discharge portion 800, respectively. The gas discharge portion 800 may be disposed outside the edge of the infrared filter 700, but is not limited thereto, and any position where the gas discharge portion 800, including the seating portion 602, may communicate with the inner space of the sub-housing 600 and the outside is possible.

The gas discharge portion 800 may communicate with the outside of the sub-housing 600 through the first opening 604 and with the inner space of the sub-housing through the second opening 605. Since the gas discharge portion 800 is inclined to form an angle with the optical axis and penetrates the sub-housing 600, the first opening 604 and the second opening 605 may be disposed so as not to be aligned with each other but to deviate from each other based on one direction parallel to the optical axis direction.

In the present embodiment, one gas discharge portion 800 is shown in the sub-housing 100, but the present disclosure is not limited thereto, and a plurality of gas discharge portions 800 may be provided.

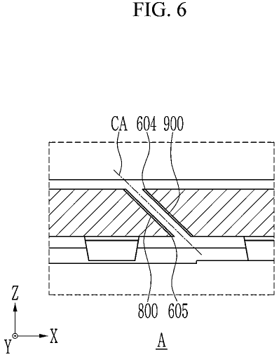

Hereinafter, a sub-housing 600 of a camera module 10 according to one or more still other example embodiments will be described in detail with reference to FIG. 6. FIG. 6 illustrates an enlarged cross-sectional view of portion A of a camera module according to one or more still other example embodiments.

Referring to FIG. 6, an adhesive portion 900 may be disposed to cover at least a portion of the gas discharge portion 800. The adhesive portion 900 may include an adhesive material. The adhesive portion 900 may be disposed to surround the inner peripheral surface of the gas discharge portion 800. The adhesive portion 900 may have a hollow cylindrical shape. The gas discharge portion 800 may have a circular cross-sectional shape. However, the adhesive portion 900 shape and the circular cross-sectional shape thereof is not limited thereto, and any shape that may cover at least a portion of the inner peripheral surface of the gas discharge portion 800 through which external gas may pass is possible.

As described above, by disposing the adhesive portion 900 on a surface of the gas discharge portion 800, even if external fluid foreign substances are introduced through the opening for gas discharge, they may be blocked.

A camera module according to one or more embodiments as described herein, may easily discharge gas caused by curing of an adhesive material to the outside, effectively block foreign materials from being introduced from the outside, and prevent a flare phenomenon from occurring.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel;
an image sensor disposed below the lens barrel along an optical axis direction of the lens barrel and electrically connected to a substrate; and
a sub-housing that is disposed between the lens barrel and the substrate and on which an infrared filter is mounted,
wherein the sub-housing comprises a gas discharge portion penetrating between first and second surfaces facing each other in the optical axis direction, and
wherein a central axis along a penetration direction of the gas discharge portion is inclined with respect to the optical axis.

2. The camera module of claim 1, wherein the gas discharge portion penetrates upper and lower portions of the sub-housing in a straight line.

3. The camera module of claim 1, wherein the gas discharge portion has a uniform width with respect to the central axis.

4. The camera module of claim 1, further comprising an adhesive portion disposed to cover at least a portion of the gas discharge portion.

5. The camera module of claim 4, wherein the adhesive portion is disposed to surround an inner peripheral surface of the gas discharge portion.

6. The camera module of claim 1, wherein the sub-housing further comprises:
a seating portion in which the infrared filter is accommodated and that is disposed to surround an opening of the sub-housing; and
a frame portion disposed on an outer portion of the sub-housing to surround the seating portion, and
wherein the gas discharge portion is disposed in the frame portion.

7. The camera module of claim 1, wherein the central axis of the gas discharge portion is inclined toward the outside of the sub-housing.

8. The camera module of claim 1, wherein
the sub-housing comprises an opening, and
the central axis of the gas discharge portion is inclined toward the opening of the sub-housing.

9. The camera module of claim 1, wherein the gas discharge portion has a hollow cylindrical shape.

10. The camera module of claim 1, wherein the gas discharge portion has a circular cross-sectional shape.

11. The camera module of claim 1, wherein the central axis of the gas discharge portion is inclined with respect to the first surface of the sub-housing.

12. The camera module of claim 1, wherein the gas discharge portion is inclined and extended so that the central axis forms a certain angle with the optical axis.

13. The camera module of claim 1, further comprising:
a lens driver configured to mount and move the lens barrel; and
a housing configured to accommodate the lens barrel and the lens driver.

14. The camera module of claim 1, wherein the gas discharge portion is disposed outside an edge of the infrared filter.
